(19) United States
(12) Patent Application Publication
(10) Pub. No.: US 2008/0270545 A1
(43) Pub. Date: Oct. 30, 2008

(54) ENHANCED MESSAGE-ID AS ELECTRONIC WATERMARK FOR ELECTRONIC MAIL FILTERING

(76) Inventor: Anthony C. Howe, Cannes (FR)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/741,527

(22) Filed: Apr. 27, 2007

(51) Int. Cl. G06F 15/16

(52) U.S. Cl. 709/206

(57) ABSTRACT

The present invention is directed to an enhanced Message-ID for an email message produced by an enhanced Message-ID generator and validator of an email system. The enhanced Message-ID comprises a symbolic name used to identify the presence of an enhanced Message-ID header, a timestamp value indicating when a modification was applied to the header, an original value of the Message-ID header, and a textual representation of a one-way security hash generated from the timestamp value, the original value, and a secret phrase.

### FIELD OF THE INVENTION

This invention broadly relates to the filtering of electronic mail messages (email), and more particularly, to the filtering of email replies received in response to previously sent email, wherein replies that contain a reference to the original sender's enhanced Message-ID are used as an electronic watermark for validation.

### BACKGROUND OF THE INVENTION

The Internet is a massive communications medium that provides its users with a convenient, fast, and inexpensive means to send email messages to other users around the globe. In many cases, the Internet has replaced the physical delivery of mail by the postal service. As result of its popularity, advertisers have turned to using email as a way to promote products with unsolicited commercial or bulk email. In addition, online thieves frequently take advantage of the email system to steal information using email borne worms and viruses. Undesirable junk email messages from these sources are often collectively referred to as “spam”.

The problem of spam has escalated to pandemic proportions and threatens every email provider's ability to deliver regular email to their users, consuming time and resources to correct. As a result, many email providers deploy policy, behavioral, and/or content based filtering methods on their mail systems. Such filtering methods suffer from a number of drawbacks. For example, content filters are prone to misidentify regular email as spam (false positives). Email identified as spam might be discarded immediately or be placed in a quarantine location for a period of time before being discarded. While a quarantine helps reduce the risk of lost email, the onus is on the recipient to check the quarantine regularly for false positives before they are automatically deleted by the mail system.

Another drawback concerns the fallout or backscatter that can occur in mail systems when spam having a falsified origin is rejected. RFC 2821 describes the Internet protocol by which email is sent between systems. The protocol states in part that if an email is accepted by a mail system and is later rejected due to errors such as unknown recipient, unknown domain name, or spam filtering, then a delivery status notification (DSN) describing the reason for the error is automatically generated by the mail system and sent back the sender. Some unsolicited bulk email and virtually all current email borne viruses contain a falsified (i.e., forged) sender address, which may correspond to a real mail address of an innocent third party, resulting in the delivery of hundreds, thousands, or possibly millions of DSN messages to the third party's mail box.

The Bounce Address Tag Validation (BATV) attempts to address the backscatter issue through modification of the envelope sender address (RFC 2821 MAIL FROM:). The proposal modifies the MAIL FROM: used during an SMTP transaction and validates the subsequent RCPT TO: of message replies. However, making changes to the MAIL FROM: can be problematic, since many SMTP servers use the MAIL FROM: address in local black-white lists and possibly other database related tasks. The BATV alterations result in a MAIL FROM: for a particular sender that varies over time. This variance complicates, if not completely negates, the ability of the receiving mail server to use the MAIL FROM: address as a constant value, particularly if the SMTP server is not BATV aware.

DomainKeys Identified Mail (DKJM) and its predecessor DomainKeys define a means by which the origin of an email can be verified and part of its contents checked for tampering. In particular, DKIM provides a means to address the issue of falsified sender addressing through the use of public-key cryptography. It operates on the information contained within the message headers to generate a cryptographic signature sent with the message for verification by a receiving mail system. DKIM cannot function like a watermark, except possibly in the case of DSN backscatter where the original message's headers are provided in a report section for informational purposes.

Some mail systems can identify the direction a message is traveling (i.e., inbound or outbound) and record the list of recipients in a database or cache record. This list of recipients may later be used to identify future replies from the recipients. However, such systems require additional system resources such as disk space or memory to store the list of recipients and a means to automatically age and removed old records.

### SUMMARY OF THE INVENTION

The present invention is directed to the placement of an electronic watermark in an email message (as opposed to in the protocol) as part of an RFC 2822 required Message-ID header This allows the mail system of the invention to utilize additional RTC 2822 headers, References, and In-Reply-To headers, as well as common elements of DSN and MDN messages that make use of Message-ID values, but do not interfere with their function. The invention's modification to the Message-ID are intended to be transparent and should have no impact on third party SMTP software nor the RFC 2822 specification.

In accordance with the principles of the invention, the enhanced Message-ID utilizes elements documented in REC 2822 such as the requirement that a Message-ID header is present in each and every message as a form of tracking identifier useful for error diagnostics and/or threading related messages into a conversation history. When email passes through the mail system of the invention, the Message-ID (if not already so modified) is prefixed with a method name (e.g., a symbolic name used to identify the presence of the enhanced Message-ID header), a timestamp, and an encrypted token (e.g., a textual representation of a one-way security hash generated from the timestamp value, the original value, and a secret phrase). Such a modification is referred to herein as an “Enhanced Message-ID as Electronic Watermark” or “EMEW”. Although the preferred implementation of the invention involves Internet mail protocols, it should be appreciated by those of ordinary skill in the art that the EMEW generation and validation techniques set forth herein may be applied to other protocols such as SMS (i.e., for sending text messages to mobile phones), without departing from the scope of the invention.

The present invention differs from DKIM in that the receiver never validates an EMEW found in the Message-ID header of an inbound email, since the receiver has no knowledge as to how the EMEW was generated by the sender. The receiver only returns a reference to the EMEW (e.g., through RFC 2822 documented headers or DSN/MDN messages) in subsequent correspondence with the original sender in order to obtain preferential treatment by the original sender's mail system. A receiving mail system may later (in the role of sender) generate its own EMEW, and then validate the EMEW upon its return in future correspondence. EMEWs from different mail systems are unique and may only be validated by the mail system they originated from. According to some embodiments of the invention, when DKIM and EMEW technology are used together, then the generation of an EMEW occurs before the DKIM signing process. In contrast to conventional auto white list implementation, the enhanced Message-ID of the invention does not require long term storage using up valuable disk space or memory. The EMEW is carried along with each message and its overhead is minimal compared to the standard Message-ID.

In accordance with the principles of the invention, when a recipient of an email containing an EMEW replies to the message, the new message contains References and/or In-Reply-To headers as described by RFC 2822, which include the EMEW from the original email. When the recipient's email reply is received by the mail system of the invention, the message is checked for the presence of EMEWs, wherein each located EMEW is checked in turn to verify if any were previously generated by the mail system. If an EMEW was previously generated by the mail system, then the associated email bypasses any and all content filtering and is delivered to the mail box of the original sender that initiated the conversation containing the EMEW. Accordingly, any risk of email replies being misidentified as spam by the content filters is thereby avoided. If there are no EMEWs found (or they all fail to pass), then content filtering may be applied to the message as per conventional procedures.

Similarly, if a mail system generates a DSN error message or a mail delivery notice (MDN), the message will contain a reference to the Message-ID of the original message that triggered the notice. When a DSN or MDN is received by the mail system of the invention, the message is checked for the presence of EMEWs. If present, each EMEW is verified to see if it was previously generated by the mail system of the invention. If an EMEW passes this verification test, the message is delivered directly to the original sender's mail box, bypassing any content filters. However, if the verification fails, the DSN or MDN may be rejected and discarded, because the message was not in response to any message that passed through the mail system of the invention. RFC 2821 provides that DSN or MDN messages cannot in turn generate subsequent DSN messages. Accordingly, this undesirable backscatter can be filtered out and removed. According to some embodiments, the enhanced Message-ID includes a limited life span.

According to the invention, a preferred email system of a sender for sending emails to, and receiving emails from, a recipient, comprises (i) an enhanced Message-ID generator for enhancing the standard Message-ID header to include an electronic watermark, (ii) a mail transfer agent for routing the email over the Internet or similar communications network to the recipient, and (iii) an enhanced Message-ID validator for validating whether an incoming email from the recipient contains a valid enhanced Message-ID created by the email system of the sender. The mail transfer agent may be configured to receive emails of the sender having a standard Message-ID header created by a mail user agent of the email system. In some embodiments of the invention, the email system may further comprise a mail submission agent configured to perform the function of receiving emails of the sender. The enhanced Message-ID generator and enhanced Message-ID validator may be implemented as one or more software applications residing on the mail submission agent and/or the mail transfer agent. The mail submission agent and the mail transfer agent may comprise separate software applications, or may comprise a single software application operating in two different modes. The enhanced Message-ID generator determines whether the standard Message-ID header is in enhanced Message-ID format, and generates the enhanced Message-ID including electronic watermark only if the standard Message-ID is not already in enhanced Message-ID format.

According to the preferred email system, the enhanced Message-ID of the incoming email from the recipient may contain a References header appended with the enhanced Message-ID from the sender's email and/or an In-Reply-To header including the enhanced Message-ID from the sender's email. The enhanced Message-ID validator passes the incoming email to one or more content filters if the incoming email does not contain a valid enhanced Message-ID, where the email message may be rejected, discarded, or quarantined. However, the enhanced Message-ID validator passes the incoming email step directly to mail storage of the sender if the incoming email does contain a valid enhanced Message-ID, thereby bypassing any content filtering of the incoming email. The enhanced Message-ID may include a limited life span.

### BRIEF DESCRIPTION OF THE DRAWINGS

FIG. 1 (prior art) is a schematic diagram illustrating typical round-trip email flow between a sender and a recipient;

FIG. 2 is a schematic diagram illustrating round-trip email flow between a sender and a recipient in accordance with the principles of the invention, wherein content filtering may be bypassed by employing EMEW technology;

FIG. 3 is a schematic diagram illustrating EMEW generation in accordance with the principles of the invention;

FIG. 4 is a schematic diagram illustrating EMEW validation in accordance with the principles of the invention;

FIG. 5 (prior art) is a schematic diagram illustrating the effects of DSN backscatter on innocent 3rd parties; and

FIG. 6 is a schematic diagram illustrating the use of EMEW technology to neutralize DSN backscatter, in accordance with the principles of the invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Before starting a description of the Figures, some terms will now be defined.

DSN=delivery status notification, often referred to as a “bounce” message or mail delivery error.

EMEW=enhanced message-ID as electronic watermark.

MDN=mail delivery notice, often referred to a “return receipt”.

MTA=mail transfer agent for handling routing and delivery of mail from a local site to one or more remote sites.

MSA=mail submission agent, which comprises the point of entry for new electronic mail entering a network mail system.

MUA=mail user agent, which comprises the end user's mail program used to compose, send, and read mail.

SMS=short message service for sending text messages to mobile phones.

SMTP=Simple Mail Transfer Protocol, as defined by RFC 2821.

Message-ID header=a unique email identifier defined by RFC 2822 section 3.6.4.

The present invention is directed to a mail system comprising one or more mail servers used to accept email submissions, transfer email, filter email, and store email. In a preferred implementation, an electronic watermark is placed in an email message as part of an REC 2822 required Message-ID header, thereby allowing the mail system to utilize additional RFC 2822 headers, References, and In-Reply-To headers, as well as common elements of DSN and MDN messages that make use of Message-ID values, but do not interfere with their function. Specifically, when a recipient of an email containing an EMEW replies to the message, the new message contains References and/or In-Reply-To headers (as described by REC 2822) that contain the EMEW from the original email. When the recipient's email reply is received by the mail system, each located EMEW is checked to verify if any were previously generated by the mail system. If an EMEW was previously generated by the mail system, then the associated email bypasses content filtering and is delivered to the mail box of the original sender. If there are no EMEWs found (or they all fail to pass), then content filtering may be applied to the message.

If a mail system generates a DSN error message or an MDN, the message will typically contain a reference to the Message-ID of the original message that triggered the notice. In accordance with the principles of the invention, when a DSN or MDN is received by the mail system, the message is checked for the presence of EMEWs. If present, each EMEW is verified to see if it was previously generated by the mail system of the invention. If an EMEW passes this verification test, the message is delivered directly to the original sender's mail box, bypassing any content filters. However, if the verification fails, the DSN or MDN may be rejected or discarded because the message was not in response to any message that passed through the mail system of the invention. RFC 2821 provides that DSN or MDN messages cannot in turn generate subsequent DSN messages. Accordingly, this undesirable backscatter can be filtered out and removed.

The present invention differs from DKIM in that the receiver never validates an EMEW found in the Message-ID header of an inbound email, since the receiver has no knowledge as to how the EMEW was generated by the sender. The receiver only returns a reference to the EMEW (e.g., through RFC 2822 documented headers or DSN DN messages) in subsequent correspondence with the original sender in order to obtain preferential treatment by the original sender's mail system. A receiving mail system may later (in the role of sender) generate its own EMEW, and then validate the EMEW upon its return in future correspondence. EMEWs from different mail systems are unique and may only be validated by the mail system they originated from. According to some embodiments of the invention, when DKIM and EMEW technology are used together, then the generation of an EMEW occurs before the DKJM signing process. In contrast to conventional auto white list implementation, the enhanced Message-ID of the invention does not require long term storage using up valuable disk space or memory. The EMEW is carried along with each message and its overhead is minimal compared to the standard Message-ID.

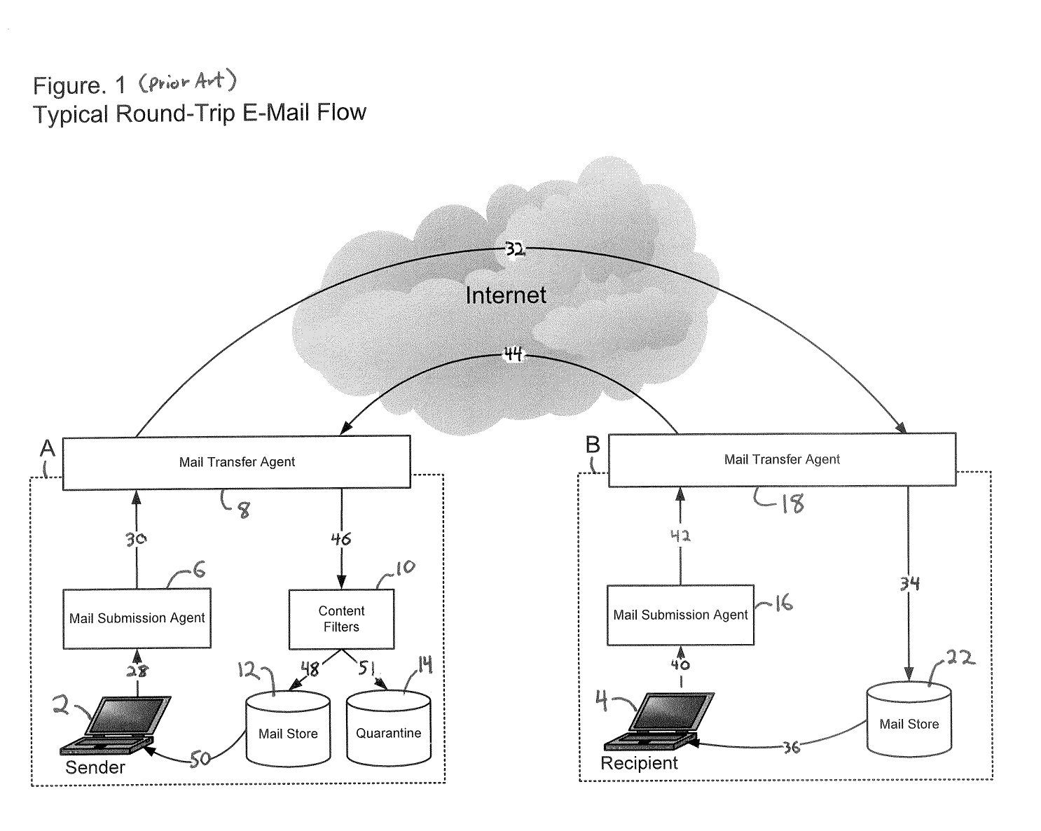

FIG. 1 (prior art) is a schematic diagram illustrating typical round-trip email flow between a sender 2 using mail system A and a recipient 4 using mail system B. In particular, mail system A comprises a mail submission agent 6, a mail transfer agent 8, content filters 10, mail storage 12 and mail quarantine 14. Mail system B comprises a mail submission agent 16, a mail transfer agent 18, and mail storage 22, and may or may not include content filters and a mail quarantine. According to a typical cycle of communication between sender 2 and recipient 4, sender 2 composes a message with their mail user agent (MUA) and submits it to the mail submission agent (MSA) 6 in step 28. It is normal for the MUA to assign a Message-ID in accordance with the RFC 2822 message format. If the MUA fails to assign a Message-ID, then the MSA 6 may assign a Message-ID according to RFC 2821 SMTP section 6.3. In step 30, the MSA 6 passes the message to the mail transfer agent (MTA) 8, and in step 32 the MTA 8 routes the email (e.g., over a network such as the Internet) to destination mail system B. The message passes through the MTA 18 and any filters in mail system B, and is then stored in a mail box 22 of the recipient 4 in step 34. The recipient 4 retrieves the message from mail box 22 in step 36.

With further reference to FIG. 1, when the recipient 4 replies to the email from the sender 2, the new message includes a Message-ID assigned by the recipient's MUA, wherein the new Message-ID is different than the original Message-ID in the message from sender 2. In addition, the MUA adds a References header appending the original Message-ID from the sender's message per RFC 2822. The References header is used to show the conversation history, and is composed of one or more Message-IDs. Additionally, an In-Reply-To header is added to the message containing the original Message-ID from the sender's email per RFC 2822. In step 40, the reply message is sent to the MSA 16 and subsequently passed on to the MTA 18 in step 42. In step 44, the MTA 18 routes the email to destination mail system A.

Upon receiving the reply message from recipient 4, mail system A passes it along to content filters 10 in step 46. Normally, the reply message passes the content filters 10 without incident and is stored in the sender's mail box 12 is step 48. In step 50, the sender 2 retrieves the reply message from mail storage 12. However, in some instances, the content filters may (for unforeseen reasons) misidentify the reply message as spam and redirect it to the quarantine 14 (step 51), reject the reply message and inform recipient 4, or simply discard the reply message. These outcomes are unfortunate since the sender 2 might not be aware that a reply from recipient 4 was ever sent. If the sender 2 is aware of the reply email, the sender 2 must find out what happened to the reply message, make sure it does not occur again, and request that the recipient 4 resend the email. The present invention help alleviates these negative outcomes caused by conventional content filters.

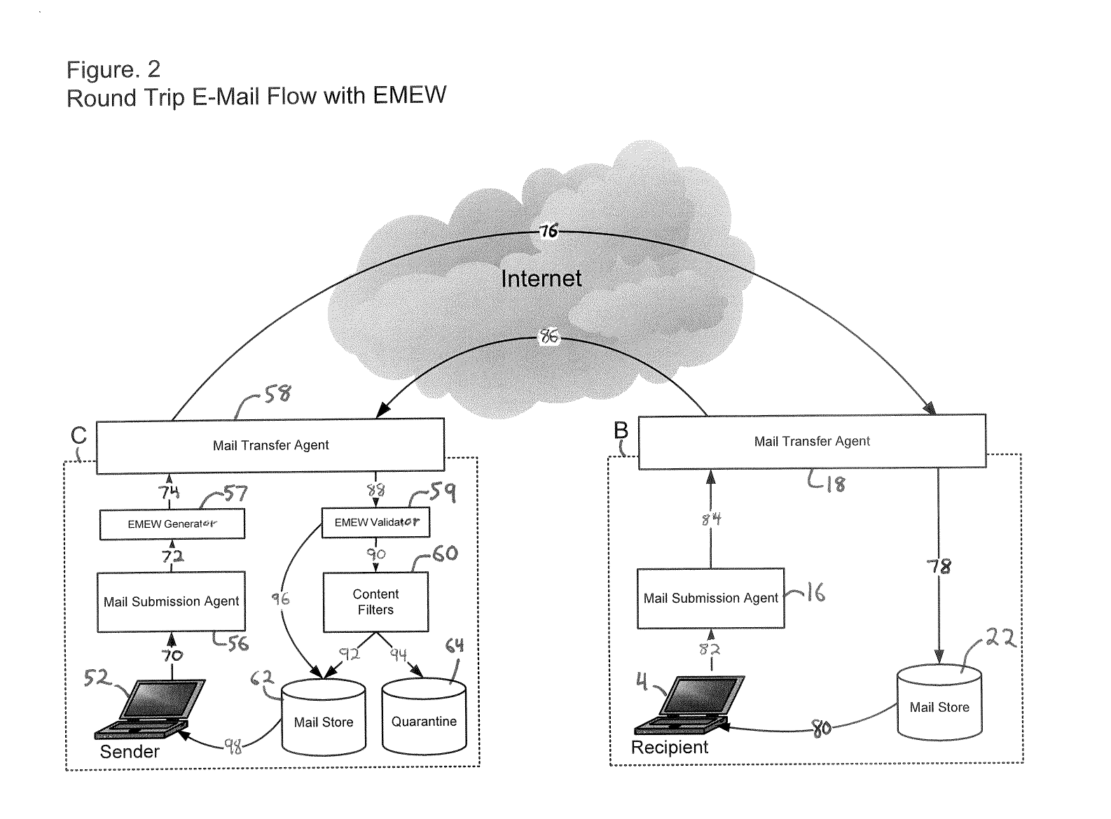

FIG. 2 is a schematic diagram illustrating round-trip email flow between a sender 52 using mail system C and a recipient 4 using mail system B, in accordance with the principles of the invention, wherein content filtering may be bypassed by employing EMEW technology. Specifically, mail system C comprises a preferred mail system of the invention and includes an MSA 56, EMEW generator 57, an MTA 58, EMEW validator 59, content filters 60, mail storage 62 and mail quarantine 64. Mail system B is similar to mail system B of FIG. 1, comprising MSA 16, MTA 18, mail storage 22, and (optionally) content filters and mail quarantine. In a typical cycle of communication between sender 52 and recipient 4, sender 52 composes a message using an MUA, and submits the message to the MSA 56 in step 70. As set forth hereinabove, the MUA may assign a Message-ID in accordance with the RFC 2822 message formnat, or if the MUA fails to do so, then the MSA 56 may assign a Message-ID according to RFC 2821 SMTP section 6.3. The EMEW generator 57 and EMEW validator 59 are preferably implemented as a software application that may reside on the MSA 56 and/or the MTA 58. The MSA 56 and MTA 58 may comprise separate software applications, or may comprise the same software application operating in two different modes. According to some embodiments of the invention, the EMEW technology may be applied to protocols other than SMTP and message formats other than the Internet Message Formnat. For example, the EMEW technology may be used in conjunction with the SMS protocol such that text messages to mobile phones are provided in EMEW format for future validation with respect to return text messages. It is possible to apply EMEW technology to any message format utilizing the concepts of (i) a unique Message-ID in a message, and (ii) a References and/or In-Reply-To header (or equivalent) that identifies when a message is in response to a parent message.

With further reference to FIG. 2, in step 72, the MSA 56 passes the message from sender 52 to the EMEW generator 57, which enhances the standard Message-ID header in accordance with the principles of the invention to generate an enhanced Message-ID. In a preferred implementation, the enhanced Message-ID may comprise the concatenation of: (a) a symbolic name to identify the presence of an enhanced Message-ID, its version, and format, such as the string “EMEW”; (b) a delimiter such as a hyphen; (c) a timestamp in textual form; (d) the textual encoding of a one-way security hash generated using the timestamp, the original Message-ID prior to modification, and a secret phrase assigned by the administrator of mail system C; (e) a delimiter such as a hyphen; and (f) the original Message-ID prior to modification. For example, if the original Message-ID header comprises, “Message-ID: <200703210809.12L89u2i020474@mail.example.com>”, then the enhanced Message-ID may comprise, “Message-ID: <EMEW-j2K49u09af7d83de957de65366263fc5bde316-200703210809.12L89u2i020474@mail.example.com>”. As would be appreciated by those of skill in the art, the above-identified enhanced Message-ID is merely exemplary, and that many different combinations and permutations of EMEW elements is possible without departing from the scope of the invention. For example, the ordering of the timestamp, symbolic name, security hash, etc., may be modified without altering the functionality of the EMEW. Additionally, the use of delimiters such as hyphens is entirely optional.

In the above example of an enhanced Message-ID, the timestamp is encoded as six alpha-numeric digits. The one-way security hash may be generated by any suitable algorithm such as Triple-DES, MD5, or SHA, and is represented as a series of hexadecimal digits. The choice of timestamp format, security hash, and secret phrase preferably are consistent within a particular mail system. Other mail systems are free to make different algorithm and secret phrase choices. The EMEW representation for at adheres to the REC 2822 Message-ID format in order to maintain transparency with all third party SMTP related software that are unaware of EMEW. According to some embodiments, the symbolic name, the delimiters (if any), and the ordering of the EMEW elements may be standardized to allow other mail systems to detect the presence of an EMEW formatted Message-ID.

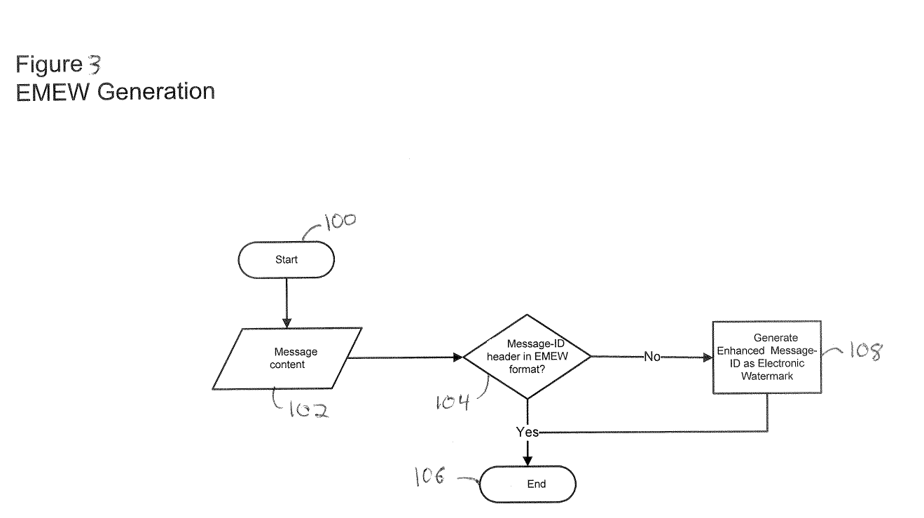

FIG. 3 is a schematic diagram illustrating EMEW generation logic of the EMEW generator 57 of FIG. 2, in accordance with the principles of the invention. Step 100 indicates the start of the logic sequence, and in step 102, the message content is received by the EMEW generator 57. In step 104, the EMEW generator 57 determines whether the Message-ID header is in EMEW format. If the determination is affirmative, the logic sequence ends in step 106, whereby the message is passed to the MTA 58. If the EMEW generator 57 determines that the Message-ID header is not in EMEW format, the sequence proceeds to step 108, wherein the EMEW generator 57 generates the enhanced Message-ID in EMEW format. Again, the logic sequence ends at 106, and the message is passed to the MTA 58.

With further reference to FIG. 2, once the Message-ID header has been modified with an EMEW value, it is passed in step 74 to the MTA 58 for routing to destination mail system B, e.g., over a network such as the Internet, in step 76. According to further embodiments of the invention, EMEW generation 57 may instead occur within the MTA 58 or at the trailing edge of the MTA 58, as long as the enhanced Message-ID is generated before perfor ing any digital signature signing processes, such as DKIM. The message passes through the MTA 18 and any filters in mail system B, and is then stored in the mail store 22 of the recipient 4 in step 78. The recipient 4 retrieves the message from mail box 22 in step 80.

When the recipient 4 receives the email from the sender 2, the Message-ID contained there in is in the above-described EMEW format, which is transparent to the recipient's MUA. When the recipient composes their reply, it will contain a standard Message-ID assigned by the MUA. In addition, the message contains a References header appending the original Message-ID in EMEW format from the sender's message, and an In-Reply-To header containing the original Message-ID in EMEW format from the sender's email. In step 82, the reply message is sent to the MSA 16 and is subsequently passed on to the MTA 18 in step 84. In step 86, the MTA 18 routes the email to destination mail system C. In the manner, the steps performed by mail system B (and recipient 4) are similar to the steps performed with respect to the conventional round-trip email flow depicted in FIG. 1, except that the recipient's reply contains references to the sender's original Message-ID in EMEW format.

Once the reply message arrives at mail system C, the MTA 58 passes it to the EMEW validator 59 in step 88. If the message did not contain a valid EMEW, mail system C would pass it to content filters 60 in step 90, whereby the message would either (i) pass the content filters 60 without incident (step 92) to the sender's mail box 62 for storage, or (ii) not pass the content filters 60 and be redirected (step 94) to the quarantine 64 (or simply rejected or discarded). However, since the message contains a valid EMEW, the content filters 60 are bypassed in step 96, and the message is passed to mail storage 62, thus preventing any possibility that the message is misidentified as spam and quarantined, rejected or discarded. In step 98, the sender 52 retrieves the reply message from mail storage 62.

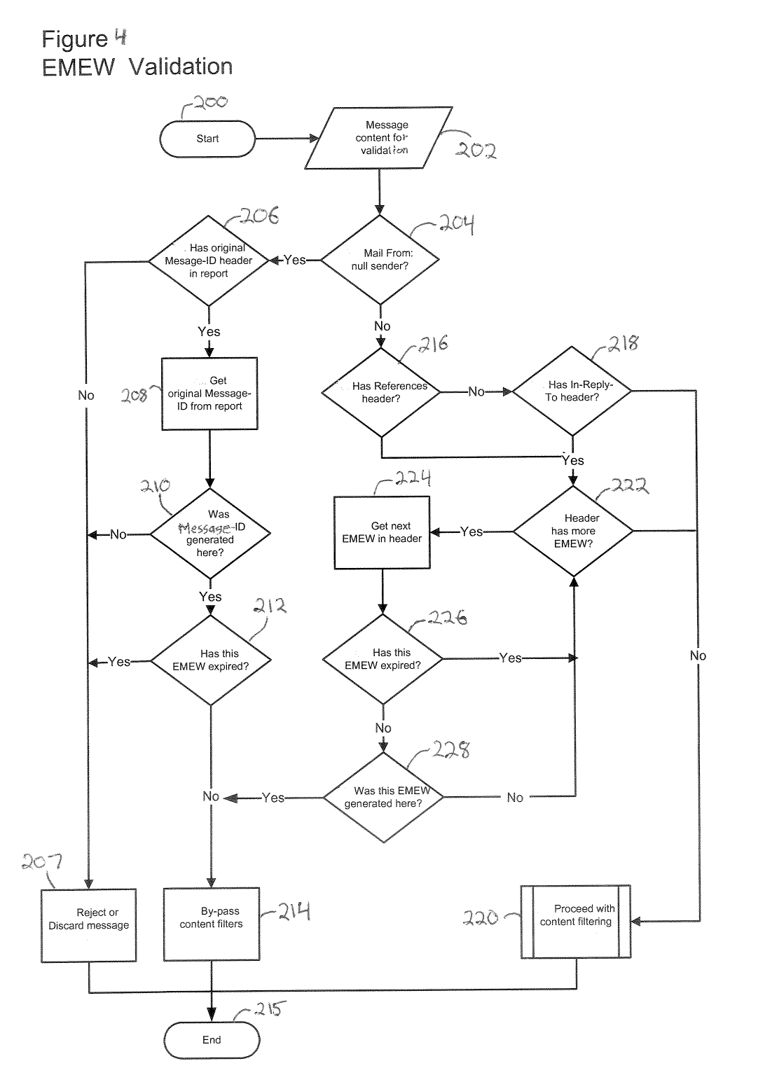

FIG. 4 is a schematic diagram illustrating an exemplary EMEW validation logic sequence performed by the EMEW validator 59 of FIG. 2, in accordance with the principles of the invention. The logic sequence begins at step 200, and in step 202, the message content is received by the EMEW validator 59 for validation. In step 204, a determination is made as to whether the email is a message system report. If a message system report is found, the sequence proceeds to step 206, wherein the validator 59 tests for the presence of a Message-ID in EMEW format. If a Message-ID in EMEW format is not found in the message system report, the message is rejected/quarantined or discarded in step 207. If a Message-ID header in EMEW format is in the report, the validator 59 retrieves it from the report in step 208, and the sequence proceeds to step 210, wherein the validator 59 determines whether the Message-ID originated from the present mail system by taking the timestamp and original Message-ID contained in the EMEW and combining this information with the mail system's secret phrase to generate a new only-way security hash. The generated hash is compared to the security hash in the EMEW for a match. If the generated EMEW and the EMEW found within the message system report do not match, the message is rejected/quarantined or discarded in step 207. Otherwise the generated EMEW and the EMEW found within the message system report do match, then sequence proceeds to step 212 to check if the EMEW has expired, in which case the message is rejected/quarantined or discarded in step 207. Otherwise, the message bypasses the content filters 60 in step 214 and the sequence ends at step 215

With continued reference to FIG. 4, if the EMEW validator 59 determines in step 204 that the message is not a message system report, the sequence proceeds to steps 216 and 218. If neither a References header nor an In-Reply-To header is found, the message is sent to the content filters 60 in step 220. However, if either a References header or an In-Reply-To header is found, then the header(s) are searched for the presence of EMEW formatted Message-IDs in step 222. If no EMEWs are found, the message is sent to the content filters 60 in step 220. If an EMEW is found in step 222, it is retrieved from the header in step 224. Step 226 involves a determination whether the EMEW has expired. If so, the sequence proceeds back to step 222 to search for additional EMEWs. If the EMEW is unexpired, the sequence proceeds to step 228 wherein the validator 59 determines whether the Message-ID originated from the present mail system in a similar manner as described for step 210. If not, the sequence proceeds back to step 222 to search for additional EMEWs. If the Message-ID originated in the present mail system, the message bypasses the content filters 60 in step 214 and the sequence ends at step 215. Accordingly, if a valid EMEW is found, the message bypasses all subsequent content filters 60 that might misidentify the reply message as spam. Similar to step 212, step 226 narrows the window of opportunity for any replay attacks by limiting the life span of an EMEW according to a predetermined administrator supplied time limit.

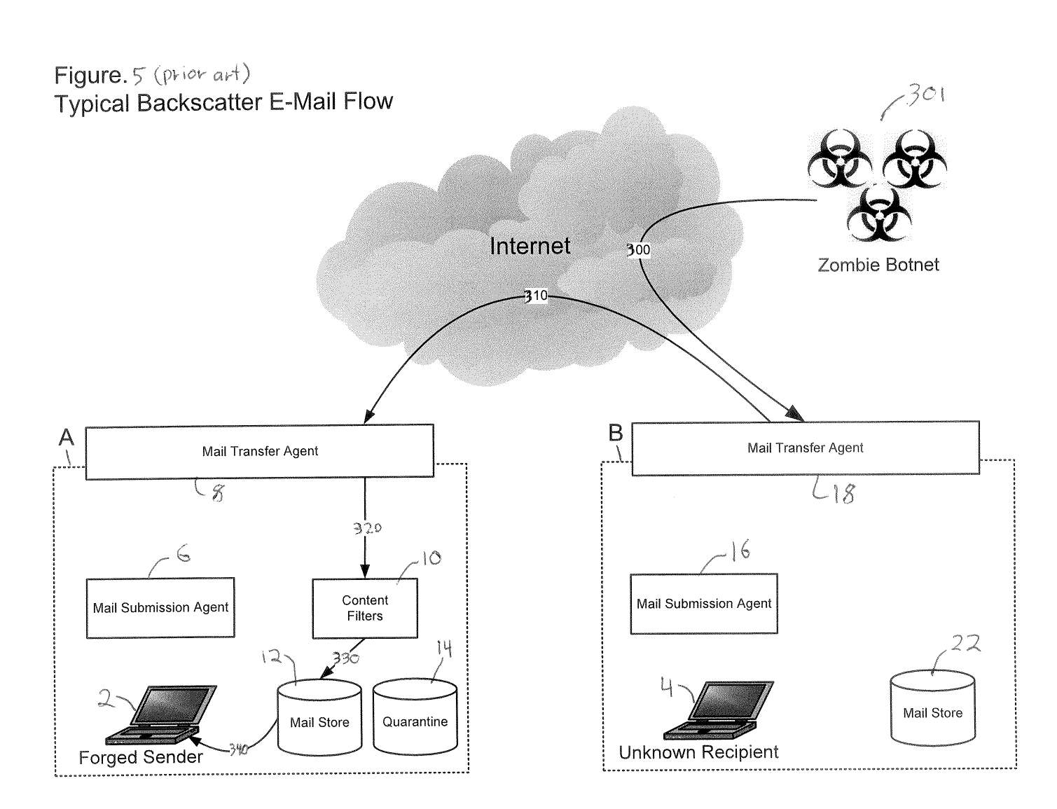

FIG. 5 (prior art) is a schematic diagram illustrating the effects of DSN backscatter on innocent 3rd parties. Mail system A and mail system B include similar configurations as provided in the conventional email flow diagram of FIG. 1, and similar elements are numbered accordingly. In particular, FIG. 5 depicts the flow of spam when the supplied sender email address has been forged and corresponds to an existing mail box somewhere on the network. By way of example, consider one or more computers infected with a virus designed to relay spam to a random, dictionary, or supplied list of recipient email addresses. In step 300, this spam (e.g., from a Zombie Botnet 301) is sent en-masse to the list of recipients including unknown recipient 4 in mail system B. Some mail systems will accept the message, apply content filtering, and then reject the message, because the specified recipient address does not exist or the message was identified as spam. RFC 2821 provides that if a mail server accepts a message and cannot deliver it, then the mail server is to send a DSN message back to the sender containing a report with a copy of all or part of the message, including the original Message-ID that generated the notice. However, because the sender address was forged in the instant case, the invalid DSN is sent in step 310 to a different mail system (mail system A). Specifically, the MTA 8 passes the invalid DSN message to content filters 10 in step 320, wherein the message passes the content filters 10 without incident and is stored in the forged sender's mail box 12 in step 330. The forged sender 2 is an innocent third party that may retrieve the invalid DSN message in step 340. Given that a typical spam run may send out millions of spam, the forged sender 2 could be flooded with a very large number of invalid DSN messages.

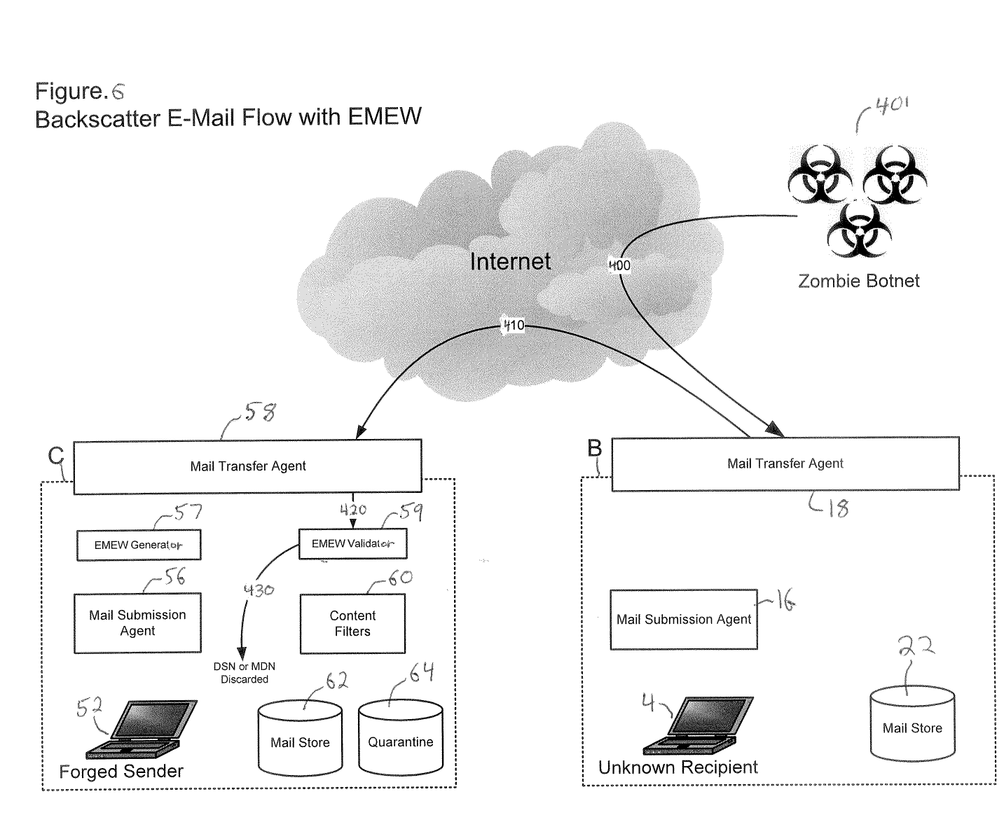

FIG. 6 is a schematic diagram illustrating the use of EMEW technology by the EMEW validator 59 of the invention to neutralize DSN backscatter, in accordance with the principles of the invention. Mail system B and mail system C include similar configurations as provided in the email flow diagram of FIG. 2, and similar elements are numbered accordingly. In step 400, the spam from Zombie Botnet 401 is sent en-masse to a list of recipients including unknown recipient 4 in mail system B. Since the sender address was forged, the invalid DSN is sent in step 410 to mail system C (including EMEW generator 57 and EMEW validator 59) of the forged sender 52. In step 420, the MTA 8 passes the invalid DSN message to the EMEW validator 59. Since mail system C modifies the Message-ID of all outbound mail with an EMEW, and because RFC 2821 reserves a special email address for automated notices, referred to as the “null address”, the validator 59 identifies the DSN or MDN, and searches for the original Message-ID header in the report. If the report does not contain the original Message-ID header, or it was not generated by mail system C, or the EMEW has expired, then the email is rejected or discarded in step 430. In this manner, mail system C eliminates backscatter such that the forged sender 52 is not deluged by irrelevant messages. If, however, the message contained a valid EMEW in a DSN or MDN, it would be assumed to be a true response to previously sent mail, and would be directly passed to mail storage 62.

The EMEW technology of the invention may be applied to any number of alternative messaging protocols and message formats other than SMTP and the Internet Message Format. As set forth hereinabove, the EMEW technology may be used in conjunction with the SMS protocol such that text messages to mobile phones are provided in EMEW format for future validation with respect to return text messages. In addition, the EMEW technology may be used in conjunction with messaging protocols including, but not limited to, simple network paging protocol (SNPP), wireless communication transfer protocol (WCTP), multimedia message service (MMS), Wireless Village, and any other messaging protocol designed for the transfer of messages between two machines/locations and sharing the concepts expressed by “message-id”, “references”, and “in-reply-to” headers.

As used herein, the termn “network” refers to any configuration of data processing devices and software connected for information interchange. For example, the network may comprise the Internet, an intranet, a local area network (LAN), a wide area network (WAN), a virtual private network (VPN), an internetwork, a personal area network (PAN), a campus area network (CAN), a metropolitan area network (MAN), or any other configuration of data processing devices and software connected for information interchange.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional.” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined ins a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

1. An enhanced Message-ID for an email message produced by an enhanced Message-ID generator of an email system, the enhanced Message-ID comprising:
a symbolic name used to identify the presence of an enhanced Message-ID header;
a timestamp value indicating when a modification was applied to the header;
an original value of the Message-ID header prior to modification; and
a textual representation of a one-way security hash generated from the timestamp value, the original Message-ID value prior to modification, and a secret phrase.

2. The enhanced Message-ID of claim 1, wherein the email system includes a message validator for detecting the presence of the enhanced Message-ID and for validating its authenticity.

3. The enhanced Message-ID of claim 1, wherein the enhanced Message-ID is located in a RFC 2822 message header including extension headers, wherein the message header utilizes a Message-ID of a parent email message.

4. The enhanced Message-ID of claim 1, wherein the enhanced Message-ID is located in a References header of the email message.

5. The enhanced Message-ID of claim 1, wherein the enhanced Message-ID is located in an In-Reply-To header of the email message.

6. The enhanced Message-ID of claim 1, wherein the enhanced Message-ID is located in a message system report containing a reference to the enhanced Message-ID.

7. The enhanced Message-ID of claim 1, wherein the enhanced Message-ID includes a limited life span.

8. The enhanced Message-ID of claim 1, wherein if the enhanced Message-ID passes validation, the email message circumvents one or more content filters.

9. The enhanced Message-ID of claim 1, wherein if the enhanced Message-ID does not pass validation, the email message is subjugated to additional filtering that may result in the message being rejected, discarded, or quarantined.

10. An email system of a sender for sending emails to, and receiving emails from, a recipient, the email system comprising:
an enhanced Message-ID generator for enhancing a standard Message-ID header of an email of the sender to include an electronic watermark;
a mail transfer agent for routing the email over a network to the recipient; and
an enhanced Message-ID validator for validating whether an incoming email from the recipient contains a valid enhanced Message-ID created by the email system of the sender.

11. The email system of claim 10, wherein the mail transfer agent is configured to receive emails of the sender having the standard Message-ID header.

12. The email system of claim 10, further comprising a mail submission agent configured to receive emails of the sender having the standard Message-ID header.

13. The email system of claim 10, wherein the enhanced Message-ID generator and enhanced Message-ID validator are implemented as one or more software applications residing on the mail transfer agent and/or a mail submission agent.

14. The email system of claim 13, wherein the mail submission agent and the mail transfer agent comprise separate software applications.

15. The email system of claim 13, wherein the mail submission agent and the mail transfer agent comprise a single software application operating in two different modes.

16. The email system of claim 10, wherein the enhanced Message-ID generator determines whether the initial Message-ID header is in enhanced Message-ID format, and generates the enhanced Message-ID including electronic watermark only if the standard Message-ID is not already in enhanced Message-ID format.

17. The email system of claim 10, wherein the incoming email from the recipient contains a References header appending the enhanced Message-ID from the sender's email.

18. The email system of claim 10, wherein the incoming email from the recipient contains an In-Reply-To header including the enhanced Message-ID from the sender's email.

19. The email system of claim 10, wherein the incoming email from the recipient contains one or more headers that contain a reference to the enhanced Message-ID from the sender's email.

20. The email system of claim 10, wherein the enhanced Message-ID validator passes the incoming email to one or more content filters if the incoming email does not contain a valid enhanced Message-ID.

21. The enhanced Message-ID of claim 20, wherein if the enhanced Message-ID does not pass validation, the email message is rejected, discarded, or quarantined.

22. The email system of claim 10, wherein the enhanced Message-ID validator passes the incoming email step directly to mail storage of the sender if the incoming email contains a valid enhanced Message-ID.

23. The email system of claim 22, wherein passing the incoming email directly to mail storage of the sender bypasses content filtering of the incoming email.

24. The email system of claim 10, wherein the enhanced Message-ID includes a limited life span.

25. An enhanced Message-ID for a message produced by an enhanced Message-ID generator of a message system, the enhanced Message-ID comprising:
a symbolic name used to identify the presence of an enhanced Message-ID header;
a timestamp value indicating when a modification was applied to the header;
an original value of the Message-D header prior to modification; and
a textual representation of a one-way security hash generated from the timestamp value, the original Message-ID value prior to modification, and a secret phrase.

26. The enhanced Message-ID of claim 25, wherein the message comprises an SMTP email message.

27. The enhanced Message-ID of claim 25, wherein the message comprises an SMS message.

28. The enhanced Message-ID of claim 25, wherein the message comprises an SNPP message, a WCTP message, an MMS message, or a Wireless Village message.
